(19) United States
(12) Patent Application Publication
(10) Pub. No.: US 2015/0046198 A1
(43) Pub. Date: Feb. 12, 2015

(54) Computer Network Platform for Consolidated Transport Services

(71) Applicant: John Daniel, Washington, DC (US)

(72) Inventor: John Daniel, Washington, DC (US)

(21) Appl. No.: 13/961,164

(22) Filed: Aug. 7, 2013

(51) Int. Cl. G06Q 30/06; G06Q 10/02

(52) U.S. Cl. CPC G06Q 30/0611; G06Q 10/02
USPC 705/5

(57) ABSTRACT

A consolidated transport booking network platform is disclosed. This system offers the options of combined services of multiple cross-sectional carriers in one booking. The system also offers automatic payment process and real-time service pricing that takes into account of profit margin and commissions.

### FIELD OF THE INVENTION

The present invention relates to a computer network platform for transportation services, more particularly, the present invention provides an integrated computer network platform for cross-sectional consolidated transport services that allows built-in real time price quotations for customers.

### DESCRIPTION OF THE RELATED ART

Spending in the U.S. logistics and transportation industry totaled nearly $1.3 trillion in 2011. This includes Air and express delivery services (EDS), Freight rail, Logistics services, Maritime and Trucking. Motor carriers collected $604 billion in revenues, or about 81 percent of total revenue earned by all domestic transport modes. For conventional handling a shipment through a carrier or to relocate from one state to another, it involves phone calls, emails, quotations and many different groups of people. Because there are many options of many carrier entities and companies, not one online destination where a customer can view all the options in one place, the process may become very stressful and redundant, people may encounter multiple calls from different companies and may even have to answer calls weeks after the shipment has already been dispatched.

US 2006/0155554 describes a method of graphically representing management of goods in a supply chain includes receiving goods management data in a computer system from participants in a supply chain, the goods management data being sent upon the participants managing individual goods, and generating a graph in the computer system using the goods management data, the graph showing the management of the individual goods over time. A computer-implemented tool may generate a display area that shows the management of individual goods over time by the participants. The goods management may be graphically represented as cumulative curves.

US 2012/0078743 describes a bidding system for transport jobs and bidding on various aspects of the transport jobs. For example, a carrier may bid on transportation of cargo while fuel providers may bid on the fuel provision. In some arrangements, the carriers may solicit bids for a fueling portion of a transport job that they wish to bid on, have already bid on or have won. Transport may correspond to the physical conveyance of cargo from origin to destination and may include vehicle costs, driver costs, carrier fees and the like. Fuel costs may refer to the cost of fuel and/or pumping fees.

US 2009/0074545 describes methods and apparatus for selecting and combining packages in an outbound container by employing autonomous transfer and transport vehicles which move on a network of roadways to carry a plurality of individual cases each containing the same kind of product from a loading station and to a destination station where individual packages are combined in the outbound container. The travel of each vehicle through the roadway network is computer controlled, and each vehicle includes means for automatically loading and unloading packages from predetermined locations on the network.

However, there is no integrated cross-sectional network platform where carriers do not need to bid a service, and a customer can get an instant real price quotation from all carriers.

### SUMMARY

A comprehensive transportation service brokerage computer platform that is based on a novel algorithm for real time price quotation and performance evaluation is disclosed. The system encompasses the services provided by carriers in freight, relocation, junk removal, auto shipping, rental and passengers.

In one aspect of an embodiment, multiple options are provided for customers to determine what they are transporting. The options encompass all the logistics of each service. Quotes are displayed in real time, as opposed to other systems that need to call or email the prices which may take days to receive.

In one aspect of an embodiment, carriers are provided custom API to feed and update their own tariffs and prices automatically into the system. In one aspect of an embodiment carrier performance is continuously monitored and evaluated based on the combination of several factors that include customer review, carrier background, whether they are licensed, bonded or insured, number of years in business and what are their affiliations.

In one aspect of an embodiment, carriers will have the ability to offer discounts and to entice customers by offering them for alternatives and options for expediency of deliveries by the combined services of several other carriers, and the customer select the combination of several carriers from one site, saving time and money. Customers can choose what method of transport according to their budget and timeframe needs.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a diagram of an example functional flow of an embodiment in accordance to this application.

FIG. 2 is an illustrative diagram for the calculation of an instant price quotation in accordance to this application.

FIG. 3 illustrates an example set of functional components for a carrier user interface in accordance to this application.

FIG. 4 is an illustrative diagram for monitoring carrier performance and the calculation of number of halos in accordance to this application.

FIG. 5 illustrates an example customer user interface in accordance to this application.

FIG. 6 illustrates an example consolidated shipping option in combining multiple carriers in accordance to this application.

FIGS. 7A, 7B and 7C illustrate an example process of managing a consolidated shipping option of multiple carriers in accordance to this application.

### DETAILED DESCRIPTION OF THE PREFERRED EMBODIMENTS

Reference will now be made in detail to embodiments of the invention. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, Java, COBOL, assembler, PERL, or Pythons, the like, with the various algorithms being implemented with any combination of data structures, objects, processes, routines, or other programming elements. Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

Communication between participants in the system of the present invention is accomplished through any suitable communication means, such as, for example, a telephone network, public switch telephone network, intranet, Internet, extranet, WAN, LAN, point of interaction device (e.g., point of sale device, personal digital assistant, cellular phone, kiosk terminal, automated teller machine (ATM), etc.), online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

It further will be appreciated that users may interact with like the system via any input device such as a keyboard, mouse, kiosk, personal digital assistant, handheld computer, cellular phone, and/or the like. Similarly, the invention could be used in conjunction with any type of personal computer, network computer, workstation, minicomputer, mainframe, or the like.

Each participant or user of the system of the present invention, including customers, carriers and transport agencies may be equipped with a suitable computing system to facilitate online communications and transactions with any other participants. For example, some or all participants may have access to a computing unit in the form of a personal computer, although other types of computing units may be used, including laptops, notebooks, handheld computers, smart phones, set-top boxes, kiosk terminals, and the like. Additionally other participants may have computing systems which may be implemented in the form of a computer-server, a PC server, a networked set of computers, or any other suitable implementations which are known in the art or may hereafter be devised.

As will be appreciated by one of ordinary skill in the art, the present invention may be embodied as a method, a data processing system, a device for data processing, and/or a computer program product. Accordingly, aspects of the present invention may take the form of an entirely software embodiment an entirely hardware embodiment, or combining aspects of both software and hardware embodiment. Furthermore, the present invention may take the form of a computer program product on a computer-readable storage medium having computer-readable program-code means embodied in the storage medium. Any suitable computer-readable storage medium may be utilized, including hard disks, CD-ROM, optical storage devices, magnetic storage devices, and/or the like.

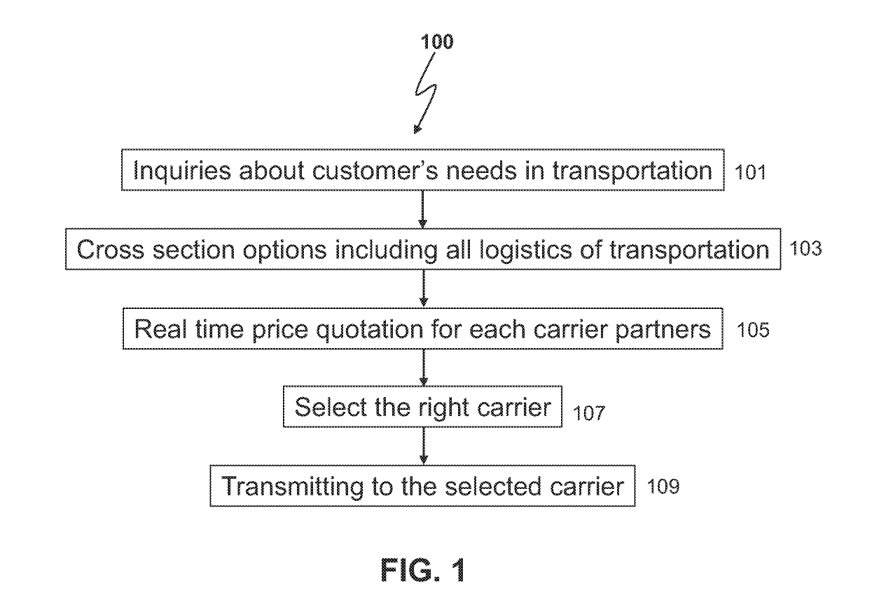

In reference to FIG. 1, an example functional flow chart of a consolidated computer network platform 100. Through an extensive network of transport carriers that spreads across the world, customers can obtain immediate price quote to decide which carrier to utilize for their transportation needs. For example, a family that is relocating would require perhaps vehicle shipping to move their family car across state borders that may need the services of multiple carriers and the customer can book the whole services all from one network site of the system, saving time and money. The computer network platform 100 includes all the necessary databases, for example, the user account databases, the carrier account databases, the necessary financial accounting modules, transactional modules for the described functions herein.

Computer network platform 100 comprises the process 101 of inquiring about a customer's needs in transportation; the process 103 of providing a cross section options of available carriers including all logistics of transportation based on the customer's needs; the process 105 of providing a real time price quotation for each of the carrier services, and the process 107 of booking the right carriers which can be a combination of multiple carriers according to the customer's needs; and the process 109 of transmitting the agreement and booking of the customer to the selected carriers.

For the process 103, it includes matching and inquiring the carrier account database about available carriers according to the customer needs collected from the process 101. For process 105, a price calculation module then calculates a real time price quotation for each of the available carriers according to the carrier's most updated price schedule and the considerations of the customer's needs. For process 107, once the customer chooses his/her choices of carriers, the system would put all the information together and provide a summary of the booking for confirmation and editing. For process 109, the customer confirms and submits his/her choices of carriers, the system then records the confirmation into each of the concerned carrier's account, and the customer's account, and also transmits such confirmation to the concerned carrier's business system.

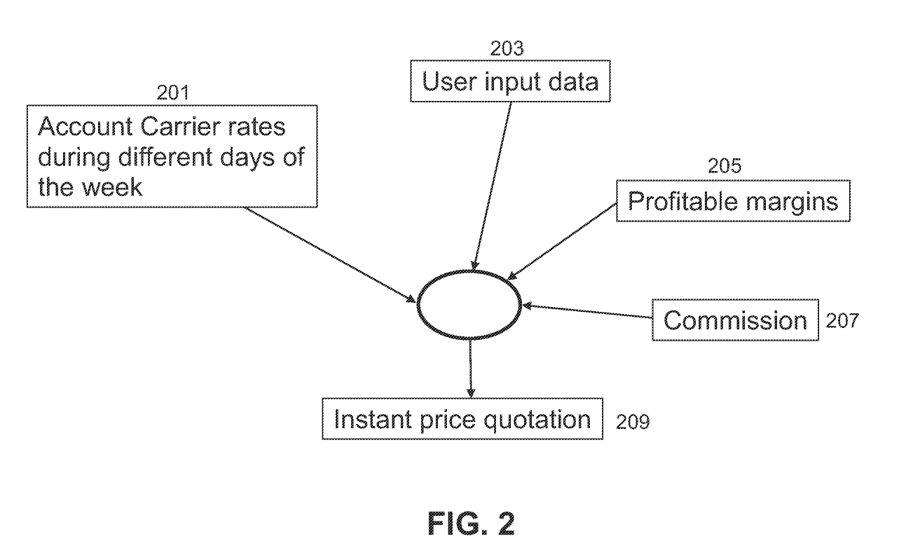

In reference to FIG. 2, the system provides an automatic real-time quoting mechanism 209 which allows a customer inputs logistical data and receives a quote within seconds. The algorithm takes into account carrier rates 201 during different days of the week and integrates this user-provided information 203, together with profitable margin 205 required by the carrier and the consideration of commission 207 of the system. Unlike an auction system, carriers no longer have to underbid to win assignments and complete shipments at a loss. Customers receive instant quotes to make a decision and do not need to worry about the carrier hiking up the price last minute. Carriers' performance reviews and evaluations and consumer ratings provide valuable assistance for a customer in making a decision.

Instantly, the customer (shipper) is able to determine which service fits he's needs and budget. Whether he or she would like to move across country with a full-service moving company, rent a truck, use a U-Load container, or just simply have his or her items removed by a junk removal company. Or if a person wants to get to a vacation spot of their choosing, and he or she has a certain budget, or time frame, they can find out through the real time quotation instantly that which carrier or service offers the cheapest vacation, whether its a cruise ship, flight, or even train. The same options are also available for renting a truck or car, or even transporting automobiles.

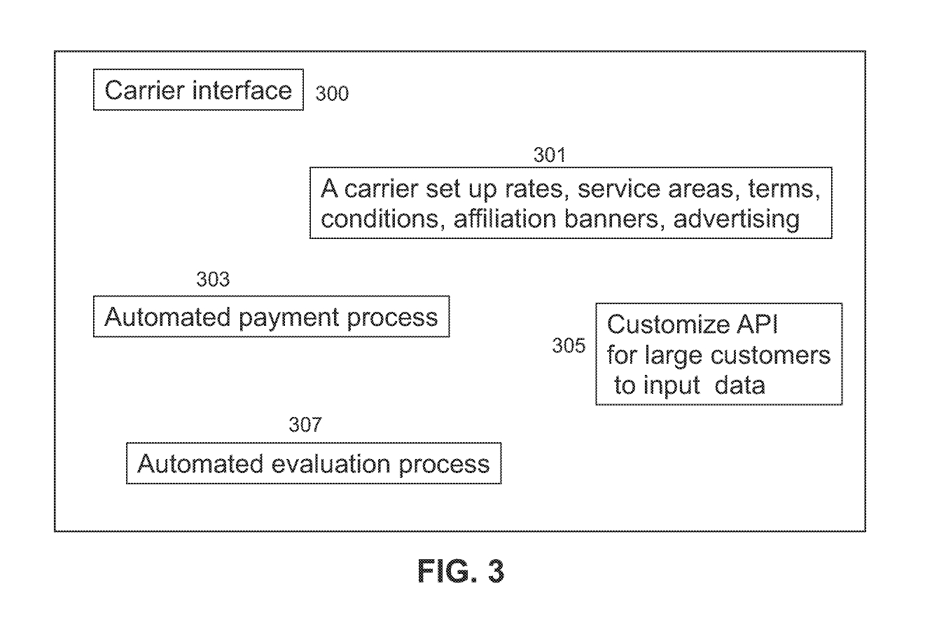

In reference to FIG. 3, the system includes a carrier friendly user interface 300 that offers carrier management module 301 with the flexibility to allow carriers to either manually set up their rates, service areas, upload their service banners and advertisements or to update their service information automatically with customized API 305. Carrier interface also includes automated payment process 303 which translates into low overheads, and automated performance evaluation module 307 that automatically monitors each carrier's service feedback and other quality assurances.

Through the carrier interface, big transport carriers could provide their rates through the API system, small transport carrier, who may not have the financial means of having API can manually enter in their pricing in their “Carrier Panel”. The system may also provide assistance in helping small firms set up their rates and to enable them to compete with the big companies.

Carriers may also have an Admin interface for setting up advertisements, banners, discounts, promos, add affiliation icons to their profile which the shipper views, as well as alter their rates at anytime.

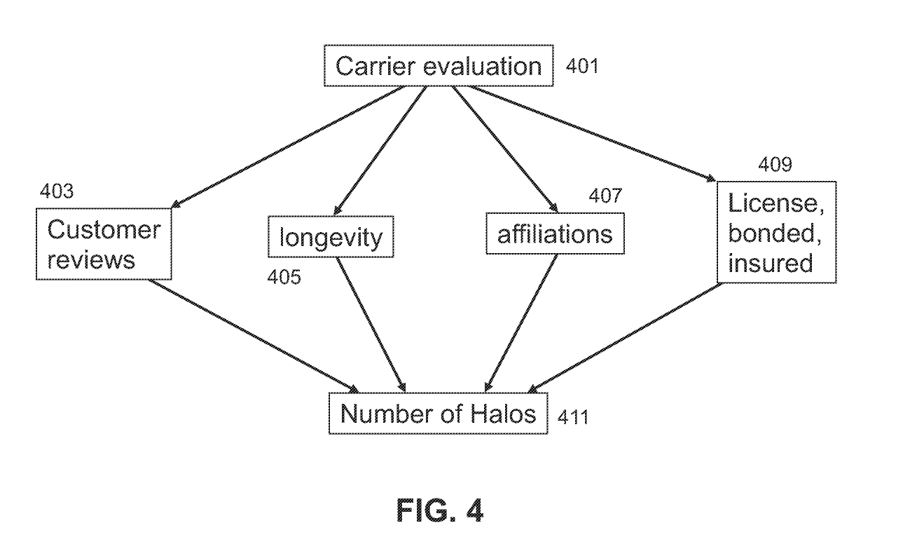

In reference to FIG. 4, an example carrier evaluation module 401 is shown. The module marks carriers with halos 411 that takes into account customer reviews 403, carrier's number of years in service 405, carrier's affiliations 407, and carrier's vetting information 409: licenses, bonded or insured etc.

The transportation business can consist of many mom-and-pop operations who cannot afford a person operated real-time quoting and marketing on their website. Using this application system, they will now be able to log into the carrier-facing portal and manage their accounts, and compete with the larger players who currently own proprietary platforms.

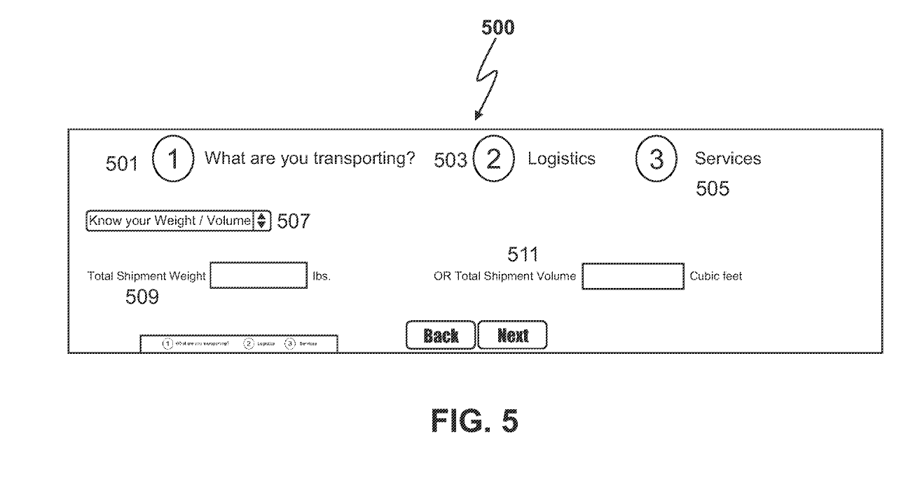

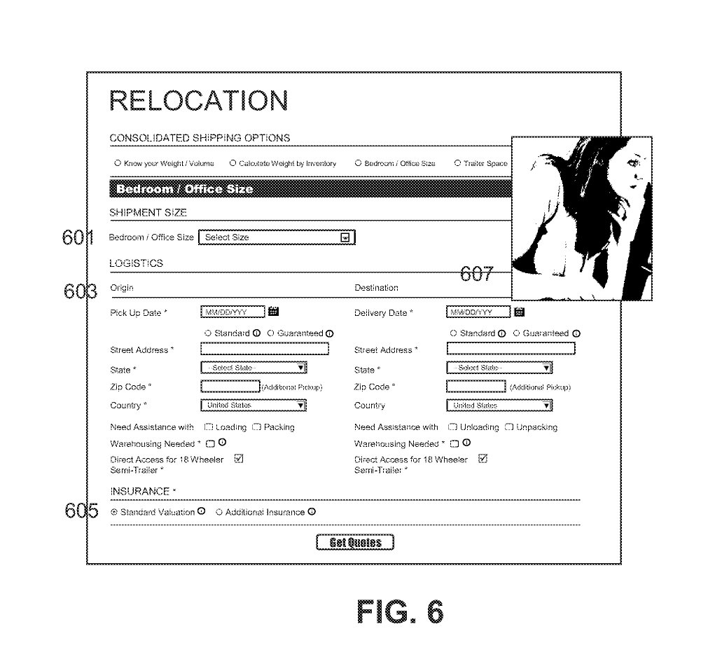

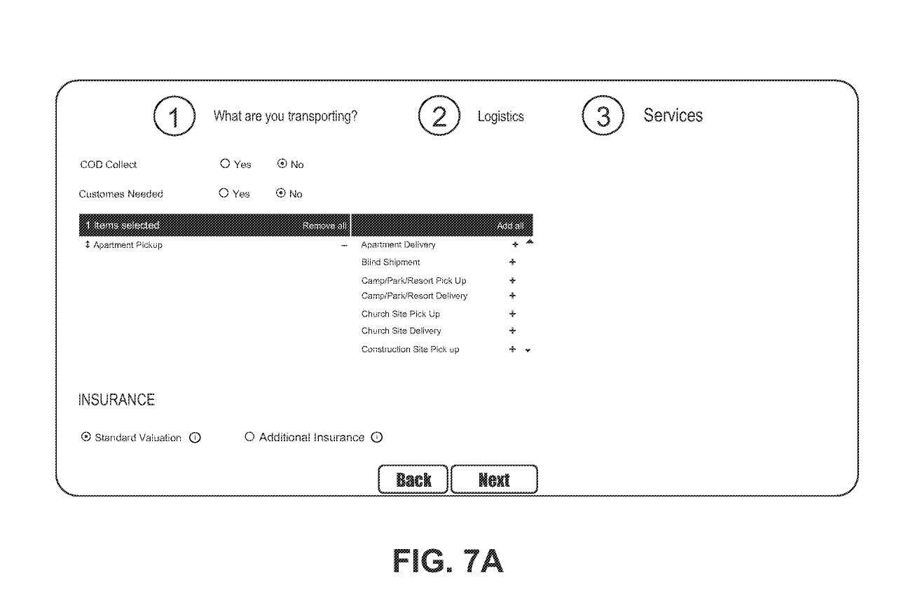

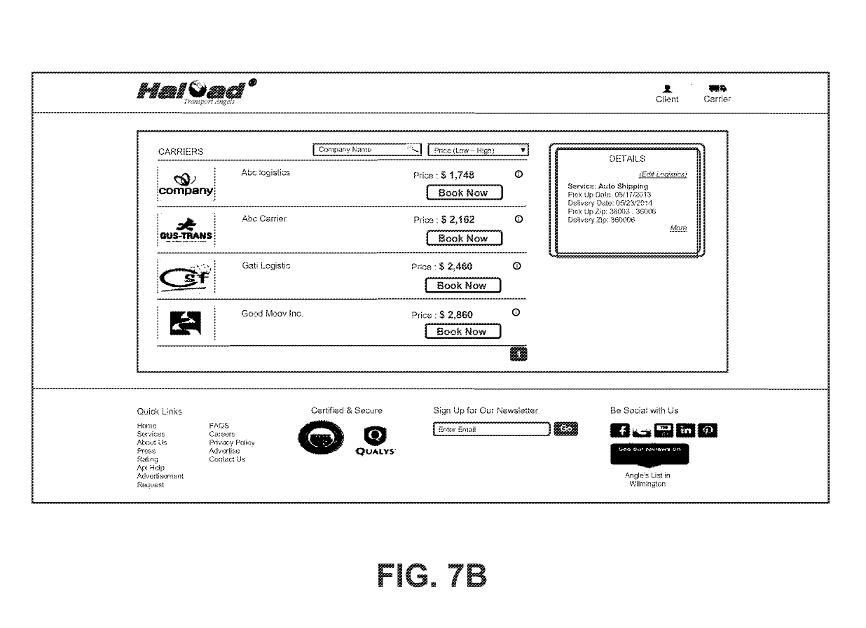

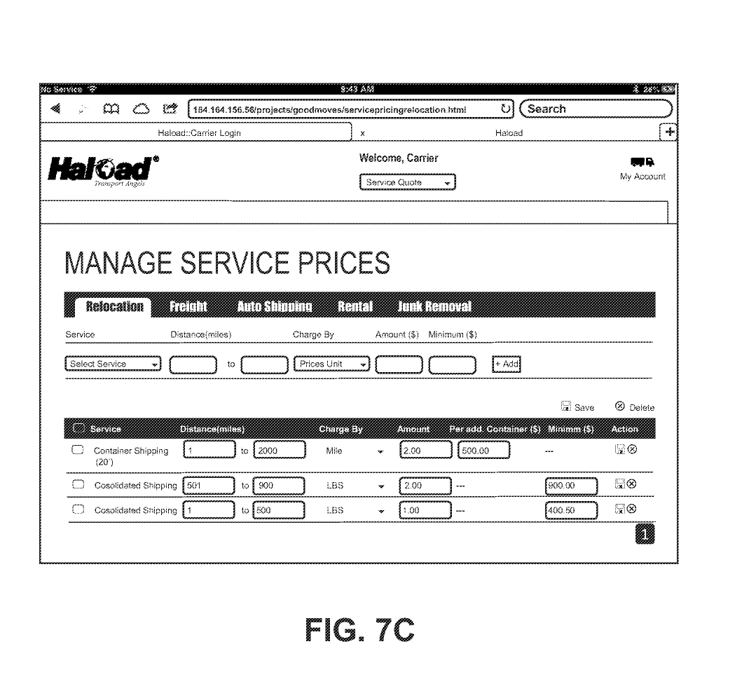

The system offers quotes for a suite of transportation options for customers through an easy-to-use streamlined interface. In reference to FIGS. 5, 6, 7A, 7B and 7C, an example web user interphase is shown for the computer network platform 100. The system is therefore a simple and easy to use site for both carriers (transportation companies) and customers (shippers). Shippers will have a four easy steps (500) to help them determine their shipment volume 507 or weight 509, what services 505 they will need, and the logistics 503. Logistics settings (FIG. 6) may include the origin 603, the destination 607, the insurance information 605 and other shipping information. Instantly the shipper will receive real time quotes from multiple Carriers (FIG. 7A) for all transportation services (FIG. 7B), and the can reserve on the site paying only, for example a 10% deposit of the total price (FIG. 7C). A shipper/customer does not need to pay for membership, no sign ups prior to getting the quotes. In for example, a less than 30 seconds, the customer will get a guaranteed price from a licensed insured carrier, that is fully vetted by system to ensure that they meet all State/Government Compliance, and who are insured and bonded.

In general, through the disclosed system, a customer gets a simple, and user friendly site which gives easy options to determine the volume/weight of loads, delivers fast pricing from highly vetted carriers. The seamless payment portal allows customers to book their shipment quick and easy!

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A consolidated computer network platform for booking transport services, comprising:
a plurality of computer processors instructed for performing the functions comprising:
a customer user interface for offering cross-sectional consolidated carrier options that comprises multiple carriers in one booking;
a carrier interface for managing carrier account information; and
a real-time quoting module for instant calculation of a real-time service price of a carrier.

2. The consolidated computer network platform of claim 1, wherein the customer user interface comprises a logistics inquiry about a customer's needs.

3. The consolidated computer network platform of claim 1, wherein the customer user interface provides a plurality of cross-sectional carriers that matches a customer's needs.

4. The consolidated computer network platform of claim 1, wherein said quoting module generates a real-time price quotation for a carrier by taking into account a carrier rate, a customer need, a profitable margin and a commission consideration of the system.

5. The consolidated computer network platform of claim 1, wherein said carrier interface comprises a module for managing a set of customized API for automation.

6. The consolidated computer network platform of claim 1, wherein said carrier interface comprises a portal for automated payment process for a carrier service.

7. The consolidated computer network platform of claim 1, further comprises a carrier evaluation module that takes into account carrier vetting information.

8. The consolidated computer network platform of claim 7, wherein said carrier evaluation module evaluates a carrier's performance using a combination of customer reviews, number of year in service, affiliation information and vetting information.

9. A method for booking transport services, comprising the steps of:
providing a computer network system that performs the steps of
providing a customer user interface for offering cross-sectional consolidated carrier options;
providing a carrier interface for managing carrier account information; and
providing a real-time service price of a carrier for a customer.

10. The method of claim 9, wherein the customer user interface comprises a logistics inquiry about a customer's needs.

11. The method of claim 9, wherein the customer user interface provides a plurality of cross-sectional carriers that matches a customer's needs.

12. The method of claim 9, wherein said a real-time service price quotation of a carrier is calculated by taking into account a carrier rate, a customer need, a profitable margin and a commission consideration of the system.

13. The method of claim 9, wherein said carrier interface comprises a module for managing a set of customized API for automation.

14. The method of claim 9, wherein said carrier interface comprises a portal for automated payment process for a carrier service.

15. The method of claim 9, further comprises the step of providing a carrier evaluation that takes into account carrier vetting information.

16. The method of claim 15, wherein said carrier evaluation step includes a consideration of a carrier's performance using a combination of customer reviews, number of year in service, affiliation information and vetting information.
